(19) United States
(12) Patent Application Publication
(10) Pub. No.: US 2025/0102360 A1
(43) Pub. Date: Mar. 27, 2025

(54) TERRESTRIAL OBSERVING NETWORK FOR DIGITAL TWINS: REAL-TIME 3D MAPPING OF METRIC, SEMANTIC, TOPOLOGICAL, AND PHYSICOCHEMICAL PROPERTIES FOR OPTIMAL ENVIRONMENTAL MONITORING

(71) Applicants: ARIZONA BOARD OF REGENTS ON BEHALF OF ARIZONA STATE UNIVERSITY, Scottsdale, AZ (US); ZANDEF DEKSIT INC., Los Angeles, CA (US); DESERT BOTANICAL GARDENS, Phoenix, AZ (US)

(72) Inventors: Jnaneshwar DAS, Tempe, AZ (US); Rakshith VISHWANATHA, Tempe, AZ (US); Cole BRAUER, Mesa, AZ (US); Zhiang CHEN, Pasadena, CA (US); Lakshmi ANTERVEDI, San Francisco, CA (US); Harish ANAND, San Diego, CA (US); Sophia DAVIS, Ithaca, NY (US); Darwin MICK, Pittsburgh, PA (US); Luiza APARECIDO, Tempe, AZ (US); Kshitij SRIVASTAVA, Seattle, WA (US); Heather THROOP, Tempe, AZ (US); Devin KEATING, Tempe, AZ (US); Alejandro CUEVA RODRIGUEZ, Tempe, AZ (US); Desmond HANAN, Riverside, CA (US); Kevin HULTINE, Phoenix, AZ (US); Amanda CLARKE, Tempe, AZ (US); Jason Achilles MEZILIS, Los Angeles, CA (US); Roberta MARTIN, Tempe, AZ (US); Elizabeth TREMBATH-REICHERT, Tempe, AZ (US); Ramón ARROWSMITH, Tempe, AZ (US)

(21) Appl. No.: 18/896,776

(22) Filed: Sep. 25, 2024

Related U.S. Application Data
(60) Provisional application No. 63/585,485, filed on Sep. 26, 2023.

(51) Int. Cl. G01J 3/28; G01J 3/02; G06V 20/10

(52) U.S. Cl. CPC G01J 3/2823; G01J 3/0272; G06V 20/188; G01J 2003/2826

(57) ABSTRACT

An environmental monitoring system with a plurality of sensor units and an imaging system. The sensor units are configured to be distributed over a monitored area and to collect spatiotemporal data. Each of the sensor units may have a temperature sensor, an air pressure sensor, a humidity sensor, a clock, and/or a Wi-Fi transceiver. The sensor units are configured to communicatively couple together to form a sensor network. The imaging system may be configured both for handheld use and for mounted use. The imaging system may have a camera and a spectrometer. The imaging system is configured to generate a real-time semantic map of the area and position the sensor units on the semantic map. The environmental monitoring system is configured to use the semantic map and the spatiotemporal data to predict a need of the monitored area and variation of the need across the monitored area.

### RELATED APPLICATIONS

This application claims the benefit of U.S. provisional patent application 63/585,485, filed Sep. 26, 2023, to Das, et al., titled “Terrestrial Observing Network for Digital Twins: Real-Time 3D Mapping of Metric, Semantic, Topological, and Physicochemical Properties for Optimal Environmental Monitoring,” the entirety of the disclosure of which is hereby incorporated by this reference.

### STATEMENT REGARDING FEDERALLY SPONSORED RESEARCH OR DEVELOPMENT

This invention was made with government support under grant no. 1521617 awarded by the National Science Foundation, under 80NSSC19C0552 awarded by the National Aeronautical & Space Administration, and under 80NSSC21K0524 awarded by the National Aeronautical & Space Administration. The government has certain rights in the invention.

### TECHNICAL FIELD

This document relates to a terrestrial observing network for digital twins and real-time 3D mapping of metric, semantic, topological, and physicochemical properties for optimal environmental monitoring.

### BACKGROUND

The increasing awareness of environmental challenges such as climate change, deforestation, pollution, and biodiversity loss has led to the growing need for reliable, scalable, and real-time environmental monitoring systems. Accurate data collection and analysis are critical for governmental bodies, private organizations, and research institutions to assess environmental health, develop sustainable practices, and respond promptly to ecological threats.

Traditional environmental monitoring systems typically rely on manual data collection, infrequent measurements, or single-point sensors, which can limit the accuracy, scope, and timeliness of the data. These systems often require significant human involvement, which increases operational costs and the potential for error. Moreover, many traditional systems are not scalable, making it difficult to deploy them across large geographical areas or integrate them with modern IoT (Internet of Things) and cloud-based technologies. Existing systems face challenges in data accuracy, energy efficiency, and real-time reporting.

### SUMMARY

Aspects of this document relate to an environmental monitoring system, comprising a plurality of sensor units configured to be distributed over a monitored area, wherein each of the plurality of sensor units is configured to collect spatiotemporal data, each of the plurality of sensor units has a temperature sensor, an air pressure sensor, a humidity sensor, a clock, and a Wi-Fi transceiver, and the plurality of sensor units are configured to communicatively couple together to form a sensor network, and a lightweight imaging system configured for handheld use and for mounted use, the imaging system having at least one camera and at least one spectrometer, wherein the imaging system is configured to generate a real-time semantic map and position the plurality of sensor units on the semantic map, wherein the environmental monitoring system is configured to use the semantic map and the spatiotemporal data to predict a need of the monitored area and variation of the need across the monitored area.

Particular embodiments may comprise one or more of the following features. The at least one camera may be a multi-spectral camera. The imaging system may further have a unibody frame configured to efficiently distribute and dissipate heat generated by the imaging system. The monitored area may be an agricultural field, the need of the agricultural field may be water, and the environmental monitoring system may be configured to predict an amount of watering needed at a plurality of points across the agricultural field. Each sensor unit may further have a solar charging interface and a rechargeable battery. Each sensor unit may further have a soil moisture and temperature probe. The plurality of sensor units may be configured to wirelessly couple together to form a wireless sensor network, wherein the wireless sensor network is configured to communicatively couple to the internet.

Aspects of this document relate to an environmental monitoring system, comprising a plurality of sensor units configured to be distributed over a monitored area, wherein each of the plurality of sensor units is configured to collect spatiotemporal data and the plurality of sensor units are configured to communicatively couple together to form a sensor network, and an imaging system having at least one camera and at least one spectrometer, wherein the imaging system is mobile and is configured to generate a real-time semantic map and position the plurality of sensor units on the semantic map, wherein the environmental monitoring system is configured to use the semantic map and the spatiotemporal data to predict a need of the monitored area and variation of the need across the monitored area.

Particular embodiments may comprise one or more of the following features. The at least one camera may be a multi-spectral camera. Each of the plurality of sensor units may have a temperature sensor, an air pressure sensor, and a humidity sensor. The monitored area may be an agricultural field, the need of the agricultural field may be water, and the environmental monitoring system may be configured to predict an amount of watering needed at a plurality of points across the agricultural field. Each sensor unit may further have a solar charging interface and a rechargeable battery. Each sensor unit may further have a soil moisture and temperature probe. The plurality of sensor units may be configured to wirelessly couple together to form a wireless sensor network, wherein the wireless sensor network is configured to communicatively couple to the internet.

Aspects of this document relate to a method for monitoring an area, the method comprising providing an environmental monitoring system comprising a plurality of sensor units and an imaging system having at least one camera and at least one spectrometer, distributing the plurality of sensor units over the area, communicatively coupling each of the plurality of sensor units together to form a sensor network, scanning the area with the imaging system, generating a semantic map of the area, wherein the semantic map includes positions of the plurality of sensor units across the area, collecting spatiotemporal data with the plurality of sensor units, associating the spatiotemporal data with the semantic map, predicting a variation of a need across the area based on the spatiotemporal data, treating the area according to the variation of the need across the area.

Particular embodiments may comprise one or more of the following features. The method may further comprise charging a battery of each of the plurality of sensor units with a solar charging interface. Communicatively coupling the plurality of sensor units together may comprise wirelessly coupling the plurality of sensor units together to form a wireless sensor network configured to communicatively couple to the internet. The spatiotemporal data may comprise temperature data, air pressure data, and humidity data. The method may further comprise inserting a soil moisture and temperature probe of each of the plurality of sensor units into the soil adjacent to the plurality of sensor units. The area may be an agricultural field and the need of the agricultural field may be water. The method may further comprise predicting an amount of watering needed at a plurality of points across the agricultural field.

The foregoing and other aspects, features, and advantages will be apparent from the DESCRIPTION and DRAWINGS, and from the CLAIMS if any are included.

### BRIEF DESCRIPTION OF THE DRAWINGS

Implementations will hereinafter be described in conjunction with the appended and/or included DRAWINGS, where like designations denote like elements, and:

FIG. 1 is an illustration of an environmental monitoring system being used to monitor an area according to some embodiments;

FIG. 2 is a schematic of an environmental monitoring system according to some embodiments;

FIG. 3 is a perspective view of an imaging system of an environmental monitoring system according to some embodiments;

FIG. 4 is a close-up view of an imaging system of an environmental monitoring system according to some embodiments;

FIG. 5 is a perspective view of a sensor unit of an environmental monitoring system according to some embodiments;

FIG. 6 is a perspective view of a sensor unit of an environmental monitoring system according to some embodiments;

FIG. 7 is a perspective view of a plurality of sensor units of an environmental monitoring system positioned on the ground according to some embodiments;

FIG. 8 is a perspective view of a plurality of sensor units of an environmental monitoring system lifted above the ground according to some embodiments; and

FIG. 9 is a perspective view of a sensor unit of an environmental monitoring system positioned in a tree according to some embodiments.

### DETAILED DESCRIPTION

Detailed aspects and applications of the disclosure are described below in the following drawings and detailed description of the technology. Unless specifically noted, it is intended that the words and phrases in the specification and the claims be given their plain, ordinary, and accustomed meaning to those of ordinary skill in the applicable arts.

In the following description, and for the purposes of explanation, numerous specific details are set forth in order to provide a thorough understanding of the various aspects of the disclosure. It will be understood, however, by those skilled in the relevant arts, that embodiments of the technology disclosed herein may be practiced without these specific details. It should be noted that there are many different and alternative configurations, devices and technologies to which the disclosed technologies may be applied. The full scope of the technology disclosed herein is not limited to the examples that are described below.

The singular forms “a,” “an,” and “the” include plural referents unless the context clearly dictates otherwise. Thus, for example, reference to “a step” includes reference to one or more of such steps.

The word “exemplary,” “example,” or various forms thereof are used herein to mean serving as an example, instance, or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is to be appreciated that a myriad of additional or alternate examples of varying scope could have been presented, but have been omitted for purposes of brevity.

When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

Throughout the description and claims of this specification, the words “comprise” and “contain” and variations of the words, for example “comprising” and “comprises”, mean “including but not limited to”, and are not intended to (and do not) exclude other components.

As required, detailed embodiments of the present disclosure are included herein. It is to be understood that the disclosed embodiments are merely exemplary of the invention that may be embodied in various forms. Therefore, specific structural and functional details disclosed herein are not to be interpreted as limits, but merely as a basis for teaching one skilled in the art to employ the present invention. The specific examples below will enable the disclosure to be better understood. However, they are given merely by way of guidance and do not imply any limitation.

The present disclosure may be understood more readily by reference to the following detailed description taken in connection with the accompanying figures and examples, which form a part of this disclosure. It is to be understood that this disclosure is not limited to the specific materials, devices, methods, applications, conditions, or parameters described and/or shown herein, and that the terminology used herein is for the purpose of describing particular embodiments by way of example only and is not intended to be limiting of the claimed inventions. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

More specifically, this disclosure, its aspects and embodiments, are not limited to the specific material types, components, methods, or other examples disclosed herein. Many additional material types, components, methods, and procedures known in the art are contemplated for use with particular implementations from this disclosure. Accordingly, for example, although particular implementations are disclosed, such implementations and implementing components may comprise any components, models, types, materials, versions, quantities, and/or the like as is known in the art for such systems and implementing components, consistent with the intended operation.

The advancement of sensor technologies, machine learning, and wireless communication has provided opportunities to enhance the capabilities of environmental monitoring systems. Emerging technologies, such as distributed sensor networks and satellite-based monitoring, allow for continuous, remote, and high-resolution data collection. These improvements offer the potential for more precise and comprehensive environmental assessments. However, existing systems still face challenges in data accuracy, energy efficiency, real-time reporting, and the integration of multiple data sources.

The present disclosure is related to an environmental monitoring system 100. The environmental monitoring system 100 is designed to automate environmental data collection, improve the accuracy and resolution of monitoring, and enable real-time analysis of environmental conditions. In addition, the environmental monitoring system 100 is designed to operate with minimal energy consumption, reduce the reliance on human intervention, and offer better scalability and adaptability across diverse environments. The environmental monitoring system 100 is configured to improve environmental monitoring through a combination of advanced sensor networks, data processing algorithms, and energy-efficient operation. The environmental monitoring system 100 is designed to collect data from multiple environmental parameters, process the information in real-time, and provide actionable insights. By integrating cloud computing and machine learning, the environmental monitoring system 100 is also configured to enhance the detection of environmental changes, allowing for more proactive and responsive environmental management.

Robotic technology has its most versatile applications when it is backed by a comprehensive network of sensors and data. This is particularly salient when used for agricultural purposes. Drone-based aerial imagery can provide information about crop stress and yield and is a common tool for in-field data collection. However, drone technology is not always in the budget range of smaller farms, and it is also not suitable for continuous monitoring as is needed by applications such as automated irrigation management.

The present disclosure facilitates next-generation 4D environmental monitoring, enabling the observation of dynamic changes in environmental characteristics over time in 3D. The present disclosure thus facilitates the development of highly accurate and probabilistic (introspective) digital twins for Earth's ecosystems.

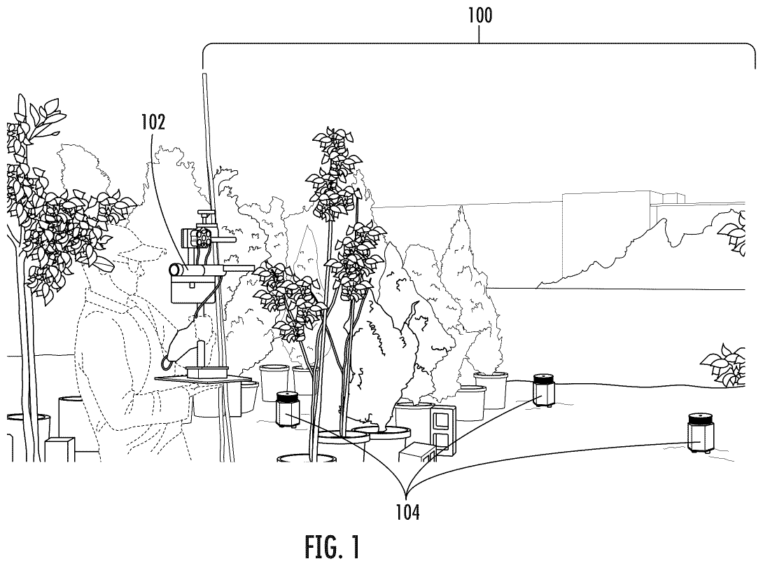

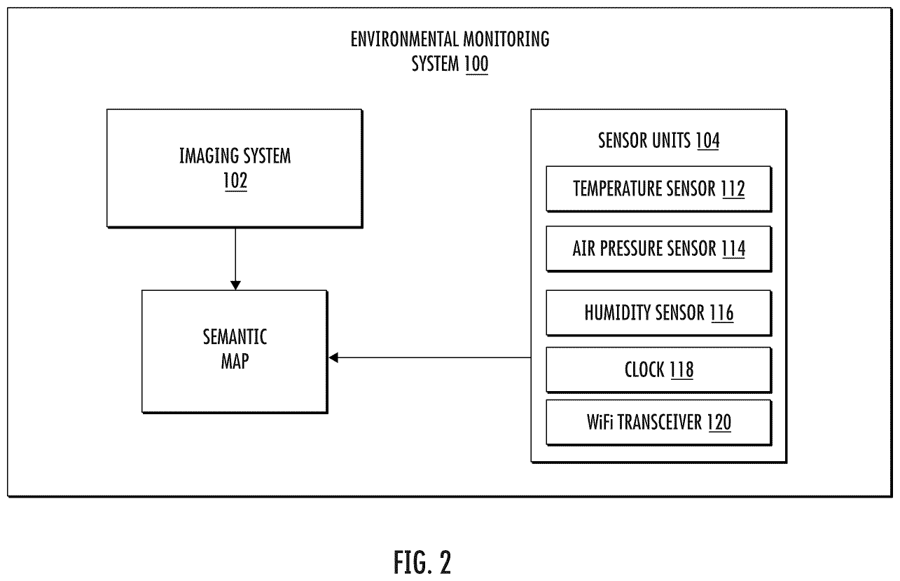

The environmental monitoring system 100 may comprise an imaging system 102 and a plurality of sensor units 104, illustrated in FIGS. 1-9. The imaging system 102 and the plurality of sensor units 104 are configured to function together to provide the improved environmental monitoring described above. The environmental monitoring system 100 is configured to be deployed and/or implemented in an area that the user desires to monitor. The monitored area may be any environmental area, including an agricultural field or orchard, an urban area, a rural area, a forested area, and a wilderness area.

The imaging system 102 is configured to perform a scan of the monitored area, as shown in FIG. 1. The imaging system 102 may be lightweight to enable easier mobility for the imaging system 102, thus enabling the imaging system 102 to be used in more environments, particularly those that are more rugged and remote. The imaging system 102 may be configured for handheld use such that a user can lift the imaging system 102 and carry the imaging system 102 around the monitored area to scan the monitored area. The imaging system 102 may also be configured for mounted use and may be mounted aboard a ground vehicle, an aerial vehicle such as a drone, or any other vehicle configured to carry the imaging system 102 around the monitored area. The imaging system 102 may be manually driven or carried around the monitored area by a user, may be driven or carried by a remote-controlled vehicle, or may be driven or carried by an autonomous vehicle. The imaging system 102 may be configured to use online semantic mapping in place of offline data analysis. Online semantic mapping allows real-time estimation of trait distributions across the monitored area. For instance, while traversing along a row of trees, or while observing a stretch of desert dryland, real-time 3D mapping allows informative tour planning, and easy transitioning to autonomous robot operations.

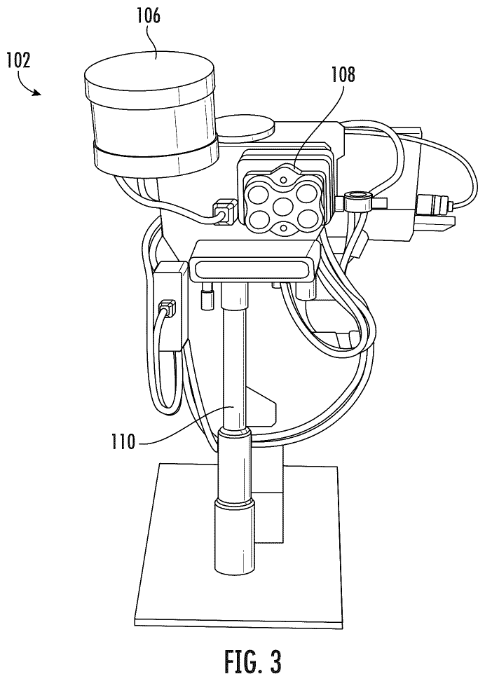

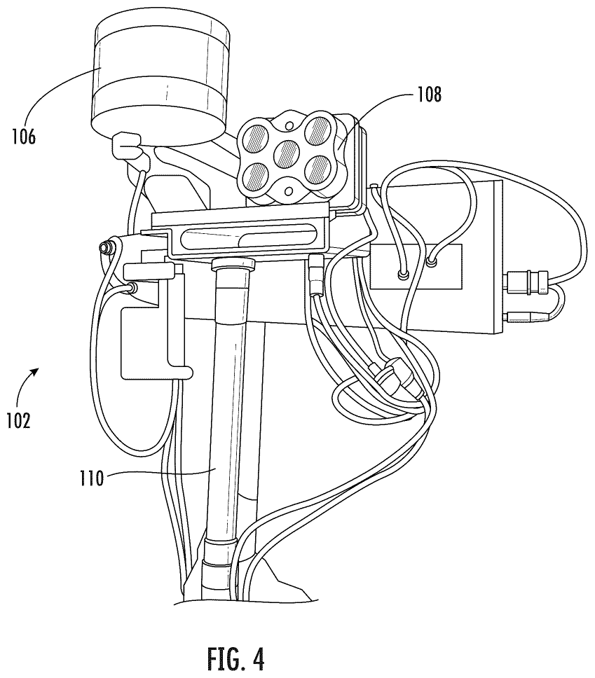

The imaging system 102 may comprise at least one camera 106 and/or at least one spectrometer 108, as shown in FIGS. 3-4. Other sensors, such as LiDAR (Light Detection and Ranging), may be implemented as well. The at least one camera 106 may comprise a VIS camera and/or a multi-spectral camera. The at least one spectrometer 108 may comprise a UV-VIS-NIR spectrometer. Other potentially useful cameras, spectrometers, and other sensors include the Velodyne 16LP LiDAR, MicaSense Altum multispectral camera with thermal band, OceanInsights UV-VIS-NIR spectrometer, FLIR PointGrey Chameleon3 global shutter 90 fps camera, Intel Realsense T265 tracking camera, and other similar devices. The imaging system 102 may also have an onboard computer, such as an Intel NUC i7 as a particular example. Additionally, the Pixhawk Cube Orange Flight Controller and Here+GPS with RTK support may be implemented. These devices may help to ensure accurate and reliable state-estimation. A person of skill in the art will understand that any microcontroller or computer could be implemented on the imaging system 102. In some embodiments, the imaging system 102 is configured for data collection at a rate of 6 GB/sec, though any data collection rate may be implemented. The data collection rate may be controlled by a Robot Operating System (ROS) onboard the imaging system 102. Processing may also be carried out onboard the imaging system 102 using a suite of algorithms that includes algorithms from visual SLAM (Simultaneous Localization and Mapping) and photogrammetry.

The imaging system 102 may have a frame 110 that is configured to support the components of the imaging system 102. In some embodiments, the frame 110 is formed or built of aluminum and may be welded and/or may be a unibody frame. The frame 110 may be used to promote efficient electronics and camera heat distribution and dissipation. In this way, the frame 110 may enable prolonged operation in extreme heat, such as is common in the Phoenix metropolitan area. This helps to provide versatility to the imaging system 102 to deliver exceptional imaging performance in a wide range of applications, especially for digital twin synthesis.

The imaging system 102 may also be equipped with GPS for location awareness and easy conversion to a mobile sensor network. Additionally, different compute options allow efficient power management for different use cases. For example, the imaging system 102 may be implemented for object detection and segmentation, which could be leveraged for imaging of tree properties such as branch shake that may be correlated to water stress.

Robotic technology has its most versatile applications when it is backed by a comprehensive network of sensors and data. This is particularly salient when used for agricultural purposes. The imaging system 102 can provide information about crop stress and yield and can be used for in-field data collection. However, the imaging system 102 is not suitable for continuous monitoring as is needed by applications such as automated irrigation management. Thus, the imaging system 102 can be used in conjunction with the plurality of sensor units 104 to extrapolate plant stress by measuring air pressure, humidity, temperature, and soil moisture in multiple locations across the monitored area.

The plurality of sensor units 104 are configured to be distributed over the monitored area. As mentioned above, the monitored area may be any environmental area, including an agricultural field, an urban area, a rural area, a forested area, and a wilderness area. Each of the plurality of sensor units 104 is configured to collect spatiotemporal data of the monitored area. In addition, the plurality of sensor units 104 are configured to communicatively couple together to form a sensor network. This allows the spatiotemporal data collected by each of the plurality of sensor units 104 to be congregated together. Once congregated together, the spatiotemporal data may provide insight into the environmental conditions across the monitored area over time. In some embodiments, the plurality of sensor units 104 may be configured to wirelessly couple together to form a wireless sensor network. In some embodiments, the plurality of sensor units 104 implement a mesh network approach to couple together. The sensor network may be configured to communicatively couple to the internet.

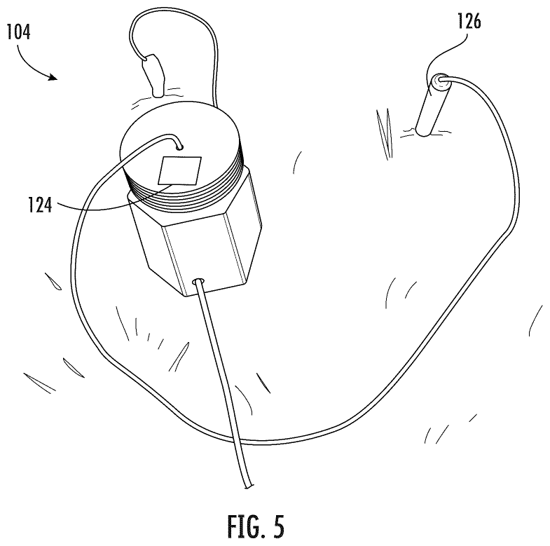

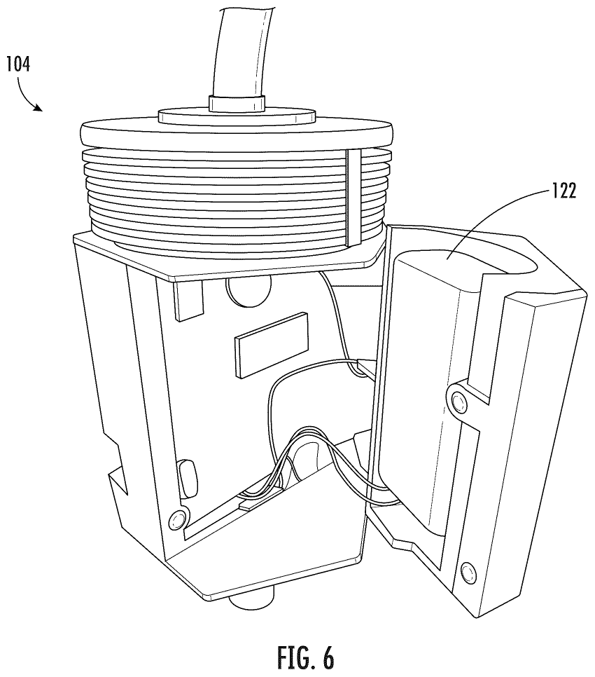

Depending on the embodiment of the environmental monitoring system 100, each of the plurality of sensor units 104 may have a temperature sensor 112, an air pressure sensor 114, a humidity sensor 116, a clock 118, and/or a Wi-Fi transceiver 120, as shown in FIGS. 5-6. Different embodiments may implement different combinations of these sensors. Other sensors may also be incorporated into each of the plurality of sensor units 104. In this way, each of the plurality of sensor units 104 can be equipped to measure desired qualities of the environment and track these qualities over time. The plurality of sensor units 104 may also each have connectors that enable interfacing with external I2C and analog sensors to allow the plurality of sensor units 104 to be adapted to specific scenarios that require specific sensors. The plurality of sensor units 104 may each have a battery 122, such as a lithium polymer (LiPo) battery. The battery 122 may be a rechargeable battery or a single-use battery. In some embodiments, the plurality of sensor units 104 may also have a solar charging interface 124 configured to recharge the battery 122 and allow the plurality of sensor units 104 to operate autonomously and indefinitely in remote locations, as long as those locations have sufficient sunlight.

Each of the plurality of sensor units 104 may also be equipped with a soil moisture and temperature probe 126 that is configured to be inserted into the soil adjacent to the sensor unit 104. The soil moisture and temperature probe 126 may be an external sensing element that interfaces with the plurality of sensor units 104. Temperature may be measured with the soil moisture and temperature probe 126 using board-mount thermistors covered in a protective epoxy. Soil moisture may be measured using the principle of interdigital capacitance. The probe may have a plurality of digits that have a predetermined thickness and a predetermined amount of space between them. Digits alternate between ground and signal planes, forming the two plates of the capacitor. The soil and its moisture content act as the dielectric constant between these two planes.

Soil capacitance may be measured using a fixed resistor and the interdigital capacitor to make up an RC network. A known voltage is applied to this RC network on the charge net, and the time it takes for the capacitor to charge to 63% of the applied voltage is measured. This is modelled using the equation:

τ=RC

Where C is the capacitance of the soil, R is the value of a fixed resistor in the measurement circuit, and τ is the charging time. Capacitance can be back-calculated with known values of R and τ.

By communicatively coupling the plurality of sensor units 104 together into a sensor network, the plurality of sensor units 104 can give a more complete picture of the environmental status across the monitored area by providing live data from points distributed across the monitored area. For example, the plurality of sensor units 104 can give a more complete picture of the water stress across a field. One benefit of the plurality of sensor units 104 forming its own sensor network in a mesh networking approach is that this facilitates the upload of data over large fields which may exceed the range of standard WiFi communication.

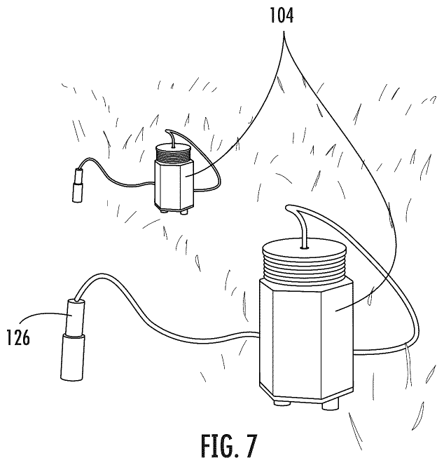

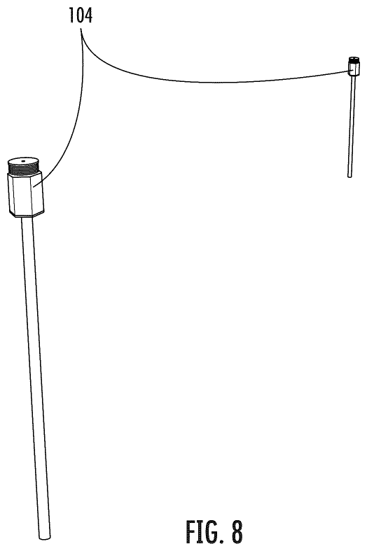

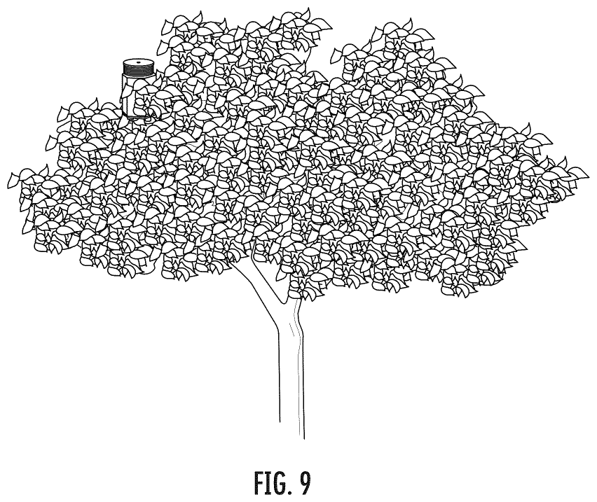

The plurality of sensor units 104 may be configured to continuous, self-powered monitoring. Each of the plurality of sensor units 104 may include a controller capable of onboard data processing and wireless data upload. When applied in agriculture, the plurality of sensor units 104 may be used to inform decisions on watering and other operations by collecting data from multiple points throughout the monitored area. The plurality of sensor units 104 is configured to provide spatiotemporal data not just in two dimensions, but also in a third dimension. This can be accomplished by placing the plurality of sensor units 104 at different heights. For example, as shown in FIGS. 7-9, the plurality of sensor units 104 can be placed on the ground (FIG. 7), lifted into the air on a stick or pole (FIG. 8) or suspended from a plant such as a tree (FIG. 9). This allows the humidity and temperature to be recorded at various heights from the ground and further helps improve the models and datasets created from the spatiotemporal data gathered by the plurality of sensor units 104.

As noted above, the imaging system 102 and the plurality of sensor units 104 are configured to work together to provide improved environmental monitoring. The plurality of sensor units 104 can be deployed to provide continuous monitoring and the plurality of sensor units 104 may be periodically deployed to provide additional imaging, whether this is through handheld deployment, on a ground vehicle, in an aerial vehicle, or on a weather balloon. The imaging data gathered by the imaging system 102 may be correlated with the spatiotemporal data gathered by the plurality of sensor units 104 to predict a need of the monitored area, as well as variation of that need across the monitored area. For example, to predict changing water stress on plants across the monitored area, the imaging system 102 may be used to gather data on leaf temperature, which may then be correlated with the spatiotemporal data gathered by the plurality of sensor units 104, such as the soil temperature and humidity at specific points across the monitored area. The imaging system 102 and the plurality of sensor units 104 may also be used to build a model that can then be used in other environments to predict which plants or regions need to be watered without the need for further imaging by the imaging system 102. The environmental monitoring system 100 can thus be used to reduce water costs and increase plant yield on farms of any size. In addition, calibration of imagery gathered with the imaging system 102 using concurrently recorded datasets from the plurality of sensor units 104 can boost predictive capabilities of drone-based crop health monitoring models.

Various algorithmic and software engineering considerations need to be taken into account when deploying the environmental monitoring system 100. In a typical usage scenario, the environmental monitoring system 100 would be deployed around a test site optimally using mutual-information or entropy-based sensor placement strategy, to maximize information gain. As the plurality of sensor units 104 collect, log, and stream data, employing adaptive sampling strategies to maximize power efficiency, the open-source DeepGIS decision support tool allows planning of ground and aerial mapping mission strategies for the imaging system 102. The imaging system 102 can then be deployed on ground in hand-held or robotic vehicle deployment mode, and the environmental monitoring system 100 maps the region with the sensor network formed by the plurality of sensor units 104. Data collection is guided by models constantly improved with live data. The onboard display on the imaging system 102 can guide humans, and in robotic deployment, the onboard flight controller is commanded by onboard companion computer to follow informative paths, with consideration to the pose and orientation of the imaging system 102, relative to the mapping target objects.

The imaging system 102 is configured to generate a real-time semantic map of the monitored area. In addition, the imaging system 102 is configured to note the position of the plurality of sensor units 104 on the semantic map. This allows the environmental monitoring system 100 to accurately correlate the spatiotemporal data gathered by the plurality of sensor units 104 with specific locations on the map generated by the imaging system 102. This, in turn, allows the environmental monitoring system 100 to use the semantic map and the spatiotemporal data to predict a need of the monitored area and variation of the need across the monitored area. In some embodiments, the monitored area is an agricultural field, and the need of the agricultural field is water. In such embodiments, the environmental monitoring system 100 is configured to predict an amount of watering needed at a plurality of points across the agricultural field. In some embodiments, the need may be different, such as a need for particular nutrients, a need for treatment for a particular pest, or any other need.

The environmental monitoring system 100 may be configured to transmit the data gathered to an outside entity or third party. To this end, the environmental monitoring system 100 may comprise equipment for wireless connection to the Internet. In a particular embodiment, the environmental monitoring system 100 may have a 915 Mhz telemetry link and a Ubiquiti Networks Bullet M2 AirMax high-throughput wireless bridge that enable efficient and seamless data transmission.

The present disclosure is also related to a method for monitoring an area. The method may comprise providing the environmental monitoring system 100, distributing the plurality of sensor units 104 over the monitored area, communicatively coupling the plurality of sensor units 104 together to form a sensor network, scanning the area with the imaging system 102, generating a semantic map of the area, wherein the semantic map includes position of the plurality of sensor units 104 across the area, collecting spatiotemporal data with the plurality of sensor units 104, associating the spatiotemporal data with the semantic map, predicting a variation of a need across the area based on the spatiotemporal data, and treating the area according to the variation of the need across the area.

The method may also comprise charging a battery of each of the plurality of sensor units 104 with the solar charging interface 124, wirelessly coupling the plurality of sensor units 104 together to form the wireless sensor network, and/or inserting the soil moisture and temperature probe 126 of each of the plurality of sensor units 104 into the soil adjacent to the plurality of sensor units 104.

The present disclosure provides several key benefits. The methods and devices disclosed herein provide real-time imaging and adaptive sampling of terrestrial environments, allowing for optimal mapping by estimating metric, semantic, and topological properties of a scene. In addition, the integration of the plurality of sensor units 104 allows for the collection of point sample measurements of physicochemical properties, which can be correlated with environmental proxy estimates from multi-spectral bands gathered by the imaging system 102. The technology disclosed herein can be applied to various fields such as tree mapping and ecological monitoring, enabling users to better understand and manage the environment. This technology also facilitates next-generation 4D environmental monitoring, enabling observation of dynamic changes in environmental characteristics over time in 3D. Lastly, the development of the environmental monitoring system 100, which allows for advanced mapping, opens up possibilities for highly accurate and probabilistic digital twins, allowing for better understanding and prediction of ecological changes. With these points in mind, the present disclosure has the potential to significantly impact environmental monitoring and management, providing invaluable insights into Earth's ecosystems.

Many additional implementations are possible. Further implementations are within the CLAIMS.

It will be understood that implementations of the environmental monitoring system include but are not limited to the specific components disclosed herein, as virtually any components consistent with the intended operation of various environmental monitoring systems may be utilized. Accordingly, for example, it should be understood that, while the drawings and accompanying text show and describe particular environmental monitoring system implementations, any such implementation may comprise any shape, size, style, type, model, version, class, grade, measurement, concentration, material, weight, quantity, and/or the like consistent with the intended operation of environmental monitoring systems.

The concepts disclosed herein are not limited to the specific environmental monitoring system shown herein. For example, it is specifically contemplated that the components included in particular environmental monitoring systems may be formed of any of many different types of materials or combinations that can readily be formed into shaped objects and that are consistent with the intended operation of the environmental monitoring system. For example, the components may be formed of: rubbers (synthetic and/or natural) and/or other like materials; glasses (such as fiberglass), carbon-fiber, aramid-fiber, any combination therefore, and/or other like materials; elastomers and/or other like materials; polymers such as thermoplastics (such as ABS, fluoropolymers, polyacetal, polyamide, polycarbonate, polyethylene, polysulfone, and/or the like, thermosets (such as epoxy, phenolic resin, polyimide, polyurethane, and/or the like), and/or other like materials; plastics and/or other like materials; composites and/or other like materials; metals, such as zinc, magnesium, titanium, copper, iron, steel, carbon steel, alloy steel, tool steel, stainless steel, spring steel, aluminum, and/or other like materials; and/or any combination of the foregoing.

Furthermore, environmental monitoring systems may be manufactured separately and then assembled together, or any or all of the components may be manufactured simultaneously and integrally joined with one another. Manufacture of these components separately or simultaneously, as understood by those of ordinary skill in the art, may involve 3-D printing, extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled or removably coupled with one another in any manner, such as with adhesive, a weld, a fastener, any combination thereof, and/or the like for example, depending on, among other considerations, the particular material(s) forming the components.

In places where the description above refers to particular environmental monitoring system implementations, it should be readily apparent that a number of modifications may be made without departing from the spirit thereof and that these implementations may be applied to other implementations disclosed or undisclosed. The presently disclosed environmental monitoring systems are, therefore, to be considered in all respects as illustrative and not restrictive.

### REFERENCES CITED AND INCORPORATED BY REFERENCE

1. Agarwal, S., K. Mierle and Others, “Ceres solver”, http://ceres-solver.org (2012)
2. Chen, S. W., G. V. Nardari, E. S. Lee, C. Qu, X. Liu, R. A. F. Romero and V. Kumar, “Sloam: Semantic lidar odometry and mapping for forest inventory”, IEEE Robotics and Automation Letters 5, 2, 612-619 (2020).
3. Dellaert, F., “Factor graphs and GTSAM: A hands-on introduction”, Tech. rep., Georgia Institute of Technology (2012).
4. Dellaert, F. and M. Kaess, “Square root sam: Simultaneous localization and mapping via square root information smoothing”, The International Journal of Robotics Research 25, 12, 1181-1203, URL https://doi.org/10.1177/0278364906072768 (2006).
5. Kaess, M., H. Johannsson, R. Roberts, V. Ila, J. J. Leonard and F. Dellaert, “isam2: Incremental smoothing and mapping using the bayes tree”, The International Journal of Robotics Research 31, 2, 216-235, URL https://doi.org/10.1177/0278364911430419 (2012).
6. Kaess, M., A. Ranganathan and F. Dellaert, “isam: Incremental smoothing and mapping”, IEEE Transactions on Robotics 24, 6, 1365-1378 (2008).
7. Romera, E., J. M. ‘Alvarez, L. M. Bergasa and R. Arroyo, “Erfnet: Efficient residual factorized convnet for real-time semantic segmentation”, IEEE Transactions on Intelligent Transportation Systems 19, 1, 263-272 (2018).
8. Milioto, A., I. Vizzo, J. Behley and C. Stachniss, “RangeNet++: Fast and Accurate LiDAR Semantic Segmentation”, in “IEEE/RSJ Intl. Conf. on Intelligent Robots and Systems (IROS)”, (2019).
9. Marshall, D., G. Lukacs and R. Martin, “Robust segmentation of primitives from range data in the presence of geometric degeneracy”, IEEE Transactions on Pattern Analysis and Machine Intelligence 23, 3, 304-314 (2001).
10. Zhang, J. and S. Singh, “Low-drift and real-time lidar odometry and mapping”, Autonomous Robots 41, 2, 401-416, URL https://doi.org/10.1007/s10514-016-9548-2 (2017).
11. Z. Chen et al., “Geomorphological Analysis Using Unpiloted Aircraft Systems, Structure from Motion, and Deep Learning,” 2020 IEEE/RSJ International Conference on Intelligent Robots and Systems (IROS), Las Vegas, NV, USA, 2020, pp. 1276-1283, doi: 10.1109/IROS45743.2020.9341354.
12. J. Das et al., “Devices, systems, and methods for automated monitoring enabling precision agriculture,” 2015 IEEE International Conference on Automation Science and Engineering (CASE), 2015, pp. 462-469, doi: 10.1109/CoASE.2015.7294123.
13. Chebrolu, Nived, Thomas Läbe, and Cyrill Stachniss. “Robust long-term registration of UAV images of crop fields for precision agriculture.” IEEE Robotics and Automation Letters 3, no. 4 (2018): 3097-3104.
14. Adeyemi, O., Grove, I., Peets, S., Domun, Y., & Norton, T. (2018). Dynamic modelling of the baseline temperatures for computation of the crop water stress index (CWSI) of a greenhouse cultivated lettuce crop. Computers and Electronics in Agriculture, 153 (January), 102-114. https://doi.org/10.1016/j.compag.2018.08.009.
15. “Real-Time Semantic Mapping of Tree Topology Using Deep Learning and Multi-Sensor Factor Graph”, thesis, Rakshith Vishwanatha, 2022, Arizona State University.
16. Rakshith Vishwanatha, Jnaneshwar Das, Roberta Martin, Heather Throop, Wenlong Zhang, Reza Ehsani, Real-Time Semantic Mapping of Tree Topology Using Deep Learning and Multi-Sensor Factor Graph, IEEE ICRA 2023 Workshop on Agricultural Robotics, May 2022, Philadelphia, PA.
17. “Navigation and Dense Semantic Mapping with Autonomous Robots for Environmental Monitoring”, thesis, ALG Prasad Antervedi, 2021, Arizona State University.

We claim:

1. An environmental monitoring system, comprising:
a plurality of sensor units configured to be distributed over a monitored area, wherein each of the plurality of sensor units is configured to collect spatiotemporal data, each of the plurality of sensor units has a temperature sensor, an air pressure sensor, a humidity sensor, a clock, and a Wi-Fi transceiver, and the plurality of sensor units are configured to communicatively couple together to form a sensor network; and
a lightweight imaging system configured for handheld use and for mounted use, the imaging system having at least one camera and at least one spectrometer, wherein the imaging system is configured to generate a real-time semantic map and position the plurality of sensor units on the semantic map;
wherein the environmental monitoring system is configured to use the semantic map and the spatiotemporal data to predict a need of the monitored area and variation of the need across the monitored area.

2. The environmental monitoring system of claim 1, wherein the at least one camera is a multi-spectral camera.

3. The environmental monitoring system of claim 1, wherein the imaging system further has a unibody frame configured to efficiently distribute and dissipate heat generated by the imaging system.

4. The environmental monitoring system of claim 1, wherein the monitored area is an agricultural field, the need of the agricultural field is water, and the environmental monitoring system is configured to predict an amount of watering needed at a plurality of points across the agricultural field.

5. The environmental monitoring system of claim 1, wherein each sensor unit further has a solar charging interface and a rechargeable battery.

6. The environmental monitoring system of claim 1, wherein each sensor unit further has a soil moisture and temperature probe.

7. The environmental monitoring system of claim 1, wherein the plurality of sensor units is configured to wirelessly couple together to form a wireless sensor network, wherein the wireless sensor network is configured to communicatively couple to the internet.

8. An environmental monitoring system, comprising:
a plurality of sensor units configured to be distributed over a monitored area, wherein each of the plurality of sensor units is configured to collect spatiotemporal data and the plurality of sensor units are configured to communicatively couple together to form a sensor network; and
an imaging system having at least one camera and at least one spectrometer, wherein the imaging system is mobile and is configured to generate a real-time semantic map and position the plurality of sensor units on the semantic map;
wherein the environmental monitoring system is configured to use the semantic map and the spatiotemporal data to predict a need of the monitored area and variation of the need across the monitored area.

9. The environmental monitoring system of claim 8, wherein the at least one camera is a multi-spectral camera.

10. The environmental monitoring system of claim 8, wherein each of the plurality of sensor units has a temperature sensor, an air pressure sensor, and a humidity sensor.

11. The environmental monitoring system of claim 8, wherein the monitored area is an agricultural field, the need of the agricultural field is water, and the environmental monitoring system is configured to predict an amount of watering needed at a plurality of points across the agricultural field.

12. The environmental monitoring system of claim 8, wherein each sensor unit further has a solar charging interface and a rechargeable battery.

13. The environmental monitoring system of claim 8, wherein each sensor unit has a soil moisture and temperature probe.

14. The environmental monitoring system of claim 8, wherein the plurality of sensor units is configured to wirelessly couple together to form a wireless sensor network, wherein the wireless sensor network is configured to communicatively couple to the internet.

15. A method for monitoring an area, the method comprising:
providing an environmental monitoring system comprising a plurality of sensor units and an imaging system having at least one camera and at least one spectrometer;
distributing the plurality of sensor units over the area;
communicatively coupling each of the plurality of sensor units together to form a sensor network;
scanning the area with the imaging system;
generating a semantic map of the area, wherein the semantic map includes positions of the plurality of sensor units across the area;
collecting spatiotemporal data with the plurality of sensor units;
associating the spatiotemporal data with the semantic map;
predicting a variation of a need across the area based on the spatiotemporal data; and
treating the area according to the variation of the need across the area.

16. The method of claim 15, further comprising charging a battery of each of the plurality of sensor units with a solar charging interface.

17. The method of claim 15, wherein communicatively coupling the plurality of sensor units together comprises wirelessly coupling the plurality of sensor units together to form a wireless sensor network configured to communicatively couple to the internet.

18. The method of claim 15, wherein the spatiotemporal data comprises temperature data, air pressure data, and humidity data.

19. The method of claim 15, further comprising inserting a soil moisture and temperature probe of each of the plurality of sensor units into the soil adjacent to the plurality of sensor units.

20. The method of claim 15, wherein the area is an agricultural field and the need of the agricultural field is water, the method further comprising predicting an amount of watering needed at a plurality of points across the agricultural field.
